(19) United States
(12) Patent Application Publication
(10) Pub. No.: US 2008/0053973 A1
(43) Pub. Date: Mar. 6, 2008

(54) METHOD AND APPARATUS FOR LASER MACHINING

(75) Inventors: CHEN-TSU FU, Chu-Nan (TW); CHUN-KAI HUANG, Chu-Nan (TW); HSIEN-TANG CHEN, Chu-Nan (TW); JUI-WEN FANG, Chu-Nan (TW); FANG-SHIUAN KUO, Chu-Nan (TW); TSUNG-FU HSU, Chu-Nan (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: FOXSEMICON INTEGRATED TECHNOLOGY, INC., Chu-Nan (TW)

(21) Appl. No.: 11/757,157

(22) Filed: Jun. 1, 2007

(30) Foreign Application Priority Data
Sep. 1, 2006 (CN) 200610062437.3

(51) Int. Cl. B23K 26/38

(52) U.S. Cl. 219/121.69; 219/121.68

(57) ABSTRACT

An exemplary method for laser machining is provided comprising: providing a workpiece, the workpiece including a predetermined machining region; loading the workpiece onto a laser machining station, the laser machining station being configured for providing an initial ambient temperature for the workpiece; heating the machining region of the workpiece up to a predetermined temperature between the initial ambient temperature and a melting temperature of a material of the workpiece; and machining the machining region with at least one laser beam. An exemplary apparatus for laser machining is also provided.

### BACKGROUND OF THE INVENTION

1. Technical Field

The present invention relates generally to methods and apparatus for laser machining, and more particularly, to a method and an apparatus for machining workpieces made of brittle materials such as a glass substrate of a TFT-LCD (thin film transistor liquid crystal display).

2. Description of the Related Art

With the continuing development of display technologies, TFT-LCD has found wide applications in consumer electronics with advantages such as lightweight, thin thickness, low driving voltage, and low power consumption, and become a strong competitor to the conventional displays such as cathode ray tubes (CRT).

A typical TFT-LCD usually includes two glass substrates with a layer of liquid crystal molecules interposed therebetween, and a number of electronic circuits. Recently, in order to maximize the productivity, a plurality of LCD panels are simultaneously formed on a glass substrate and then separated from each other so as to fabricate individual LCD panels. Since the separating process is performed almost at the last stage of the LCD manufacturing process, if a defect is generated in the LCD panels during the separating process, it will be extremely difficult to cure and productivity will thus be reduced drastically.

To separate each of the LCD panels from the glass substrate a contact type cutting method has been used. In this method a scribe line is physically formed on a surface of the glass substrate in a groove shape by using a cutter made of materials with greater hardness than glass, such as diamond. Force is then exerted on the scribe line so as to separate each of the LCD panels from the glass substrate. However, there are many drawbacks to this method including low efficiency, safety issues for the human operator and material waste.

To overcome some of the drawbacks of the contact type cutting method, non-contact type cutting methods have been developed. In a non-contact cutting process, a high-energy beam such as a laser beam is directed and focused onto a surface of the glass substrate for short periods, releasing energy and generating heat thereon. When accumulated to a sufficient amount this heat can melt or evaporate the glass at the locations where the laser beam is directed upon and thereby cut the glass along a desired path.

In a conventional laser machining process, when a laser beam is directed onto the surface of the glass substrate, the temperature at the locations where the laser beam interacts with the glass increases rapidly. At a location nearby not receiving the laser beam, the temperature increases, due to heat conduction, by an amount corresponding to the distance between that location and the locations where the laser beam is received. Resultantly a rather steep temperature gradient is formed on the glass substrate. As shown in FIG. 1, the temperature drops rapidly from the machining locations where the laser beam interacts with the glass to locations further away. Such temperature gradient imposes a gradient of heat expansion within the glass substrate and creates a stress concentration therein. The stress often further leads to the formation of small cracks in undesired directions along the cutting path, as shown in FIG. 2.

These small cracks can easily spread upon a further applied small stress, vibration or impact, making the glass substrate easy to break in undesired ways, especially during transportation. In addition, if the unexpected cracks spread to a display panel formed on the glass substrate, a serious defect is generated in the display panel.

Therefore, what is needed is to provide a method and apparatus for laser machining a brittle workpiece by which the formation of small cracks due to machining can be substantially avoided.

### SUMMARY OF THE INVENTION

A laser machining method in accordance with a preferred embodiment is provided. The laser machining method includes: providing a workpiece, the workpiece including a predetermined machining region; loading the workpiece onto a laser machining station, the laser machining station being configured for providing an initial ambient temperature for the workpiece; heating the machining region of the workpiece up to a predetermined temperature between the initial ambient temperature and a melting temperature of a material of the workpiece; and machining the machining region with at least one laser beam.

A laser machining apparatus in accordance with a preferred embodiment is provided. The laser machining apparatus includes a laser machining station for supporting a workpiece thereon and providing an initial ambient temperature for the workpiece; a heating source configured to heat a machining region (i.e., region for machining) of the workpiece up to a predetermined temperature between the initial ambient temperature and a melting temperature of a material of the workpiece; and at least one laser beam source adapted to generate at least one laser beam for machining the workpiece.

Compared with the related art, said laser machining method comprises heating the machining region of the workpiece with a heating source before machining the workpiece in the heated region with at least one laser beam generated by at least one laser beam source. Because the machining region of the workpiece is preheated before being machined, the temperature gradient therein during the process of machining is reduced and the gradient of heat expansion of the workpiece material at different machining locations on the workpiece is thus reduced. Consequently the formation of small cracks on the workpiece due to machining is substantially avoided.

Other advantages and novel features will become more apparent from the following detailed description of embodiments when taken in conjunction with the accompanying drawings.

### BRIEF DESCRIPTION OF THE DRAWINGS

Many aspects of the present method and apparatus for laser machining can be better understood with reference to the following drawings. The components in the drawings are not necessarily drawn to scale, the emphasis instead being placed upon clearly illustrating the principles of the present method and apparatus for laser machining.

FIG. 1 is a graph of temperature vs. distance from the machining region of a workpiece that is laser machined by the method and apparatus in accordance with the related art;

FIG. 2 partially shows a resultant machining region of a workpiece that is laser machined in accordance with the related art, wherein small cracks are formed as a result of a relatively large temperature gradient within the machining region as shown in FIG. 1;

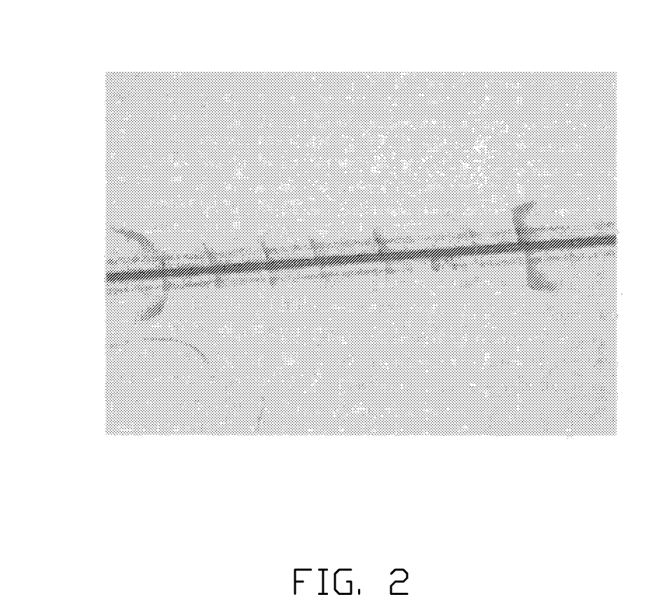

FIG. 3 is a schematic view of an exemplary apparatus for laser machining in accordance with a preferred embodiment.

FIG. 4 is a graph of temperature vs. distance from the machining region of a workpiece that is laser machined by the apparatus shown in FIG. 3;

FIG. 5 partially shows a resultant machining region of a workpiece that is laser machined by the apparatus shown in FIG. 3, wherein the formation of small cracks is substantially avoided.

### DETAILED DESCRIPTION OF THE INVENTION

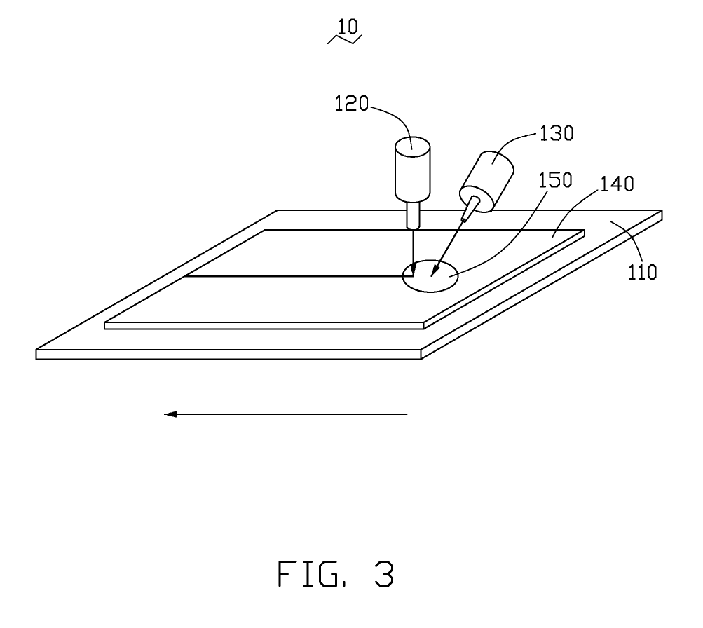

Referring to FIG. 3, a laser machining method, in accordance with a first preferred embodiment, includes:

(1): Providing a workpiece 140 and placing the workpiece 140 onto a laser machining station 110, the laser machining station 110 being configured (i.e., structured and arranged) for providing an initial ambient temperature T₀ for the placed workpiece, and the workpiece 140 including a predetermined machining region 150.

The workpiece 140 can be made of brittle materials such as glass, silica, or other ceramic materials. It is preferred that the workpiece 140 has a board-like shape.

The laser machining station 110 is adapted to support the workpiece 140 and can be made of materials such as metal.

(2): Heating the machining region 150 of the workpiece 140 to a predetermined temperature between the initial ambient temperature T₀ and the melting temperature of the workpiece material Tₘ.

A heating source 130 is adapted to heat the machining region 150 of the workpiece 140 and form a temperature field in the machining region 150 and its vicinity. The temperature of this field is predetermined substantially based on the material composition and the thickness of the workpiece 140 and should be chosen to be below the melting temperature of the workpiece material. Preferably, this temperature should be approximately between 120 degrees Celsius and 150 degrees Celsius.

The heating source 130 is an air-ejecting apparatus, which blows hot air at a predetermined temperature onto the surface of the machining region 150 of the workpiece 140 and increases the temperature of region 150 and its vicinity. The temperature of the hot air should be chosen to be between the initial ambient temperature T₀ and the melting temperature of the workpiece material Tₘ. For example, if the workpiece is made of glass, the temperature of the hot air should preferably be approximately between 120 degrees Celsius and 150 degrees Celsius. The heating performed this way is uniform and easy to control. In addition, using an air-ejecting apparatus to heat the workpiece 140 does not leave any residue on the workpiece.

(3): Machining the machining region 150 of the workpiece 140 with a laser beam generated by a laser beam source.

A laser beam is generated by a laser beam source 120 and configured to machine the workpiece 140 in the machining region 150. The laser beam source 120 can be a gaseous state laser beam source, a liquid state laser beam source, or a solid state laser beam source such as a semiconductor laser. Preferably a 355 nm wavelength 3 Watt solid-state laser beam source should be used.

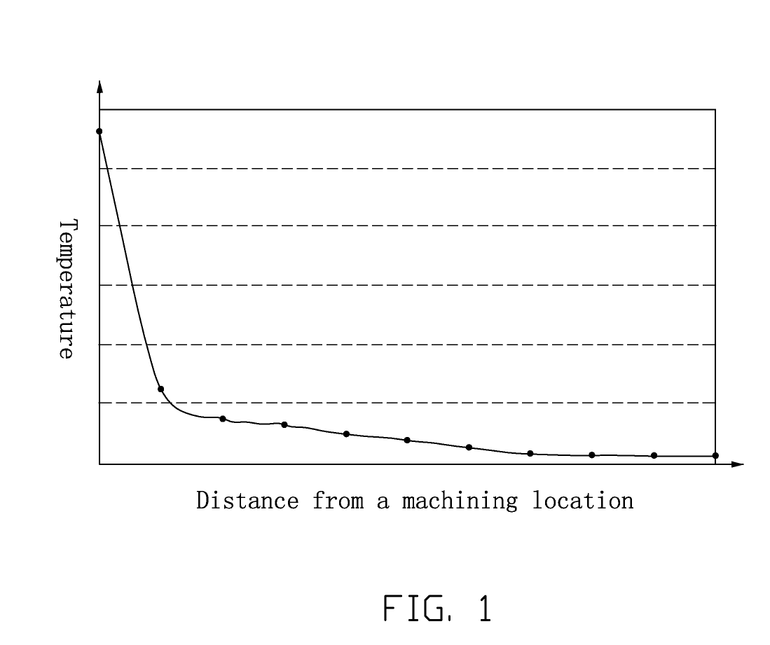

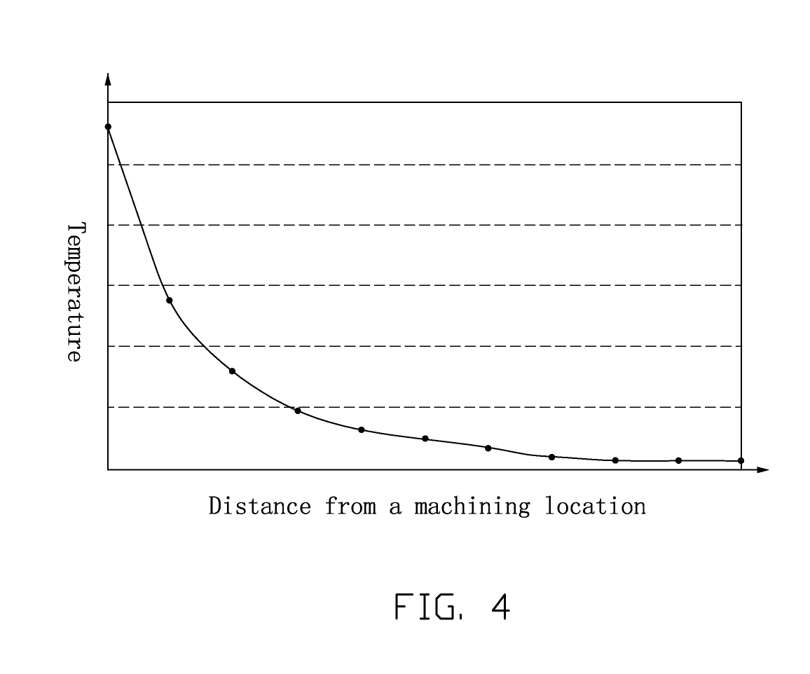

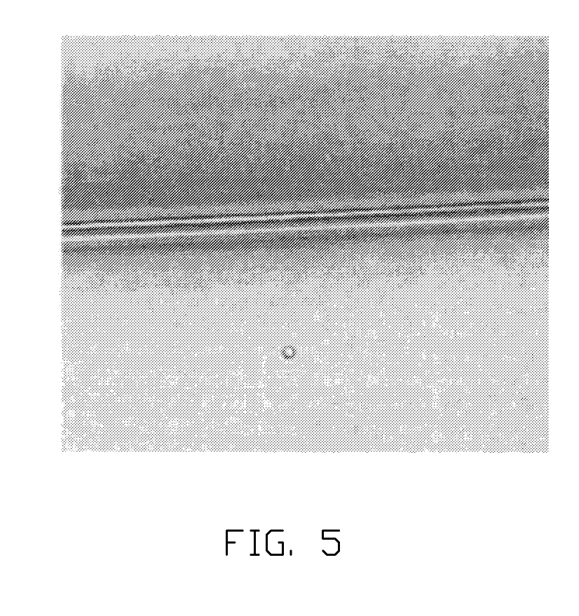

Referring to FIG. 4, when the laser beam generated by the laser beam source 120 is directed onto the machining region 150 of the workpiece 140, the temperature in region 150 is increased, peaking at the location where the laser beam interacts with the workpiece and dropping down along directions away therefrom. As a result of preheating region 150 prior to machining, the temperature drop from the machining location to locations further away on the workpiece 140 in FIG. 4 is relatively more gradual than in FIG. 1 and the temperature gradient in region 150 during the process of machining is reduced to a certain extent compared to the related art. Consequently, the corresponding gradient of heat expansion of the workpiece material in region 150 is reduced and thus the formation of small cracks is substantially avoided, as shown in FIG. 5.

Preferably, the laser beam source 120 and the heating source 130 are relatively fixed to each other, or alternatively, the heating source 130 can move relatively to the laser beam source 120 within a vicinity thereof during the process of machining. By moving the laser beam source 120 and the heating source 130 together as a whole relatively to the workpiece 140, such as moving the laser machining station 110 along the arrowed direction in FIG. 3, the whole workpiece 140 can be machined. In addition, with such a configuration, the machining region 150 can be heated by the heating source 130 consistently before that the same region is machined by the laser beam generated by the laser beam source 120 at all different intended locations on the workpiece 140. As a result, the temperature gradient within different machining regions at all different intended locations on the workpiece 140 is consistently reduced during the whole process of machining.

The heating source 130 can be other sources such as an electric oven. An electric oven can be placed under the workpiece 140 and used to heat the workpiece 140 through radiation of the heat generated by a heating resistance wire in the electric oven. The electric oven and the laser beam source 120 can move together as a whole relatively to the workpiece 140.

Compared with the related art, the laser machining method in this preferred embodiment of the present invention utilizes the heating source 130 to preheat the machining region 150 prior to laser machining the region and thereby reduces the temperature gradient and the gradient of heat expansion therein caused by the machining process. As a result, the formation of small cracks on the workpiece 140 due to machining is substantially avoided. In some cases, a cooling procedure can be applied following the laser machining process in order to further facilitate cutting the workpiece.

Referring to FIG. 3, a second preferred embodiment provides a laser machining apparatus 10, which comprises a laser machining station 110 configured to support the workpiece 140 and provide an initial ambient temperature T₀ for the workpiece; a laser beam source 120 configured to generate a laser beam for machining the workpiece 140 and a heating source 130 configured to heat a machining region 150 on the workpiece 140 to a predetermined temperature between the initial ambient temperature T₀ and the melting temperature of the workpiece material Tₘ and thereby reduce the temperature gradient in this region during laser machining.

The heating source 130 is an air-ejecting apparatus adapted to blow hot air on the surface of the workpiece 140 and thus raise the temperature thereof.

The laser beam source 120 can be a gaseous state laser beam source, a liquid state laser beam source, or a solid state laser beam source such as a semiconductor laser beam source. Preferably, a 355 nm wavelength 3 Watt solid state laser beam source should be used.

Preferably, the laser beam source 120 and the heating source 130 can be fixed to each other during the process of machining, or alternatively, the heating source 130 can move relatively to the laser beam source 120 within a vicinity thereof. In addition, the laser beam source 120 and the heating source 130 can move together as a whole relative to the workpiece 140. For example, the laser machining station 110 can move along the arrowed direction in FIG. 3, so that the whole workpiece 140 can be machined.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the present invention.

What is claimed is:

1. A method for laser machining, comprising:
providing a workpiece, the workpiece including a predetermined machining region;
loading the workpiece onto a laser machining station, the laser machining station being configured for providing an initial ambient temperature for the workpiece;
heating the machining region of the workpiece up to a predetermined temperature between the initial ambient temperature and a melting temperature of a material of the workpiece; and
machining the machining region with at least one laser beam.

2. The method according to claim 1, wherein the machining region of the workpiece is heated by a heating source and at least one laser beam is generated by at least one laser beam source.

3. The method according to claim 2, wherein during performing the machining step, the at least one laser beam source and the heating source are relatively fixed to each other.

4. The method according to claim 2, wherein during performing the machining step, the heating source is moved relative to the at least one laser beam source.

5. The method according to claim 2, wherein during performing the machining step, the heating source and the at least one laser beam source are moved together as a whole relative to the workpiece.

6. The method according to claim 2, wherein the workpiece is heated by blowing hot air thereon.

7. The method according to claim 2, wherein the workpiece is heated up to the predetermined temperature which is approximately between 120 degrees Celsius and 150 degrees Celsius.

8. An apparatus for laser machining, comprising:
a laser machining station for supporting a workpiece thereon and providing an initial ambient temperature for the workpiece;
a heating source configured to heat a machining region of the workpiece up to a predetermined temperature between the initial ambient temperature and a melting temperature of a material of the workpiece; and
at least one laser beam source adapted to generate at least one laser beam for machining the workpiece.

9. The apparatus according to claim 8, wherein the heating source is an air ejecting apparatus for blowing hot air.

10. The apparatus according to claim 8, wherein the at least one laser beam source and the heating source are fixed to each other.

11. The apparatus according to claim 8, wherein the heating source is movable relative to the at least one laser beam source.

12. The apparatus according to claim 8, wherein the heating source and the at least one laser beam source are movable together as a whole relative to the workpiece.

13. A method for laser treatment, comprising:
providing a workpiece;
heating the workpiece up to a predetermined temperature lower than a melting temperature of a material of the workpiece; and
processing the workpiece with at least one laser beam.

14. The method according to claim 13, wherein the workpiece is heated by blowing hot air onto a surface of the workpiece, whereby a substantially round heated region is formed on the workpiece.

15. The method according to claim 14, wherein the at least one laser beam is applied onto the workpiece within the substantially round heated region thereof.

16. The method according to claim 14, wherein the hot air is obliquely blown onto surface of the workpiece.
